(19) United States
(12) Patent Application Publication
(10) Pub. No.: US 2016/0068077 A1
(43) Pub. Date: Mar. 10, 2016

(54) SYSTEMS AND METHODS FOR FUEL CELL AIR FILTER LIFE PREDICTION

(71) Applicant: GM GLOBAL TECHNOLOGY OPERATIONS LLC, DETROIT, MI (US)

(72) Inventors: JOCK W.H. SMITH, BOWMANVILLE (CA); JOSEPH K. MOORE, WHITBY (CA); LEI LI, WHITBY (CA); WILLIAM H. PETTIT, ROCHESTER, NY (US)

(21) Appl. No.: 14/479,741

(22) Filed: Sep. 8, 2014

(51) Int. Cl. B60L 11/18; H01M 8/04; H01M 8/06

(52) U.S. Cl. CPC B60L 11/1883; H01M 8/0687; H01M 8/04664; H01M 2250/20

(57) ABSTRACT

Methods and apparatus are provided for fuel cell air filter life prediction. The method for monitoring an air filter comprises receiving data indicating a concentration of a contaminant gas, and receiving data indicating a mass flow rate through the air filter. The method also comprises determining, with a processor, a total mass of the contaminant gas based on the concentration of the contaminant gas and the mass flow rate and calculating, with the processor, a remaining life of the air filter based on the total mass of the contaminant gas and a capacity of the air filter for the contaminant gas. The method comprises outputting notification data to a notification system based on the calculated remaining life of the air filter.

### TECHNICAL FIELD

The present disclosure generally relates to fuel cells and more particularly relates to systems and methods for fuel cell air filter life prediction for a vehicle.

### BACKGROUND

Certain vehicles employ a fuel cell system to generate power for the operation of the vehicle. Generally, fuel cell systems include a fuel cell stack that generates electrical energy from a chemical reaction. In the example of a polymer exchange membrane (PEM) fuel cell, oxygen and hydrogen react to generate electrical energy and water. In the example of a PEM fuel cell, the oxygen source, air, can be filtered using an air filter. Exposure to certain contaminants in the air, such as dust and certain chemical gases, however, may reduce the life of the air filter and may degrade the performance of the fuel cell.

Accordingly, it is desirable to provide improved systems and methods for fuel cell air filter life prediction. Furthermore, other desirable features and characteristics of the present invention will become apparent from the subsequent detailed description and the appended claims, taken in conjunction with the accompanying drawings and the foregoing technical field and background.

### SUMMARY

In one embodiment, a method is provided for monitoring an air filter. The method comprises receiving data indicating a concentration of a contaminant gas, and receiving data indicating a mass flow rate through the air filter. The method also comprises determining, with a processor, a total mass of the contaminant gas based on the concentration of the contaminant gas and the mass flow rate and calculating, with the processor, a remaining life of the air filter based on the total mass of the contaminant gas and a capacity of the air filter for the contaminant gas. The method comprises outputting notification data to a notification system based on the calculated remaining life of the air filter.

In one embodiment, a vehicle is provided. The vehicle comprises an air filter and at least one sensor that measures a concentration of a gas. The vehicle further comprises a mass flow sensor disposed downstream of the air filter that measures a mass flow rate through the air filter. The vehicle also comprises a notification system. The vehicle comprises a module that determines a remaining life of the air filter based on the concentration of the gas, the mass flow rate and a capacity of the air filter for the gas, and outputs notification data to the notification system based on the remaining life of the air filter.

### DESCRIPTION OF THE DRAWINGS

The exemplary embodiments will hereinafter be described in conjunction with the following drawing figures, wherein like numerals denote like elements, and wherein:

FIG. 1 is a functional block diagram illustrating a vehicle that includes an air filter system in accordance with various embodiments;

FIG. 2 is a dataflow diagram illustrating a control system of the air filter system in accordance with various embodiments;

FIG. 3 is a flowchart illustrating a control method of the air filter system in accordance with various embodiments;

FIG. 4 is a flowchart illustrating a control method of the air filter system in accordance with various embodiments;

FIG. 5 is a flowchart illustrating a control method of the air filter system in accordance with various embodiments;

FIG. 6 is a flowchart illustrating a control method of the air filter system in accordance with various embodiments;

FIG. 7 is a flowchart illustrating a control method of the air filter system in accordance with various embodiments; and

FIG. 8 is a flowchart illustrating a control method of the air filter system in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality. In addition, the units used herein are merely exemplary.

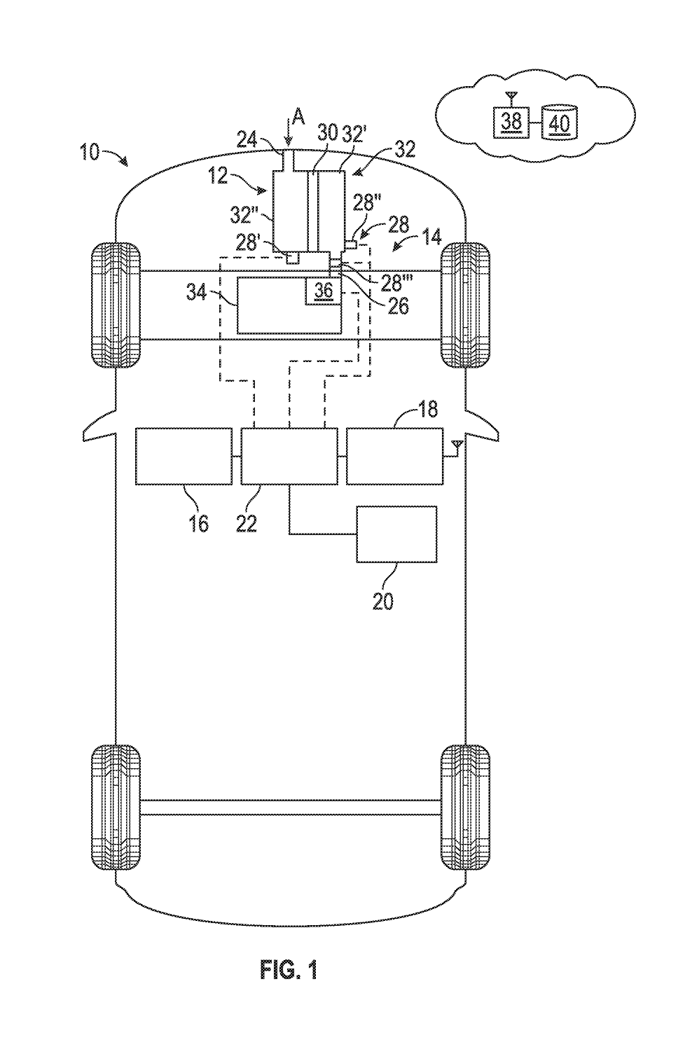

With reference to FIG. 1, a vehicle 10 is shown. The vehicle 10 includes an air filter system 12, a powertrain 14, a notification system 16, a telecommunication system 18, a global positioning system (GPS) system 20 and a module 22 in accordance with various embodiments. Although the figures shown herein depict an example with certain arrangements of elements, additional intervening elements, devices, features, or components may be present in an actual embodiment. It should also be understood that FIG. 1 is merely illustrative and may not be drawn to scale.

The air filter system 12 filters air for use by a portion of the powertrain 14. In one example, the air filter system 12 includes an air inlet 24, a gas outlet 26, one or more sensors 28 and an air filter 30. The air filter system 12 is housed in a suitable housing 32, which is divided by the air filter 30 into a clean or first side 32′ and a dirty or second side 32″. The air inlet 24 is defined through a portion of the housing 32, and enables air external to the vehicle 10 to enter into the housing 32. Thus, the air inlet 24 is defined in the housing 32 so as to be upstream from the air filter 30. As the air is external, untreated air, the air enters through the air inlet 24 into the housing 32 on the second side 32″.

The gas outlet 26 is in communication with a portion of the powertrain 14 to provide the portion of the powertrain 14 with filtered or clean gas. The gas outlet 26 is defined through a portion of the housing 32 on the first side 32′, downstream from the air filter 30.

In one embodiment, the one or more sensors 28 include a dirty or first gas sensor 28′, a clean or second gas sensor 28″ and a mass flow sensor 28″. The one or more sensors 28 are in communication with the module 22 over a suitable communication architecture or arrangement. The first gas sensor 28′ measures and observes an air quality of the incoming air and generates sensor signals based thereon. Generally, the first gas sensor 28′ measures and observes the presence of chemical gases in the air. In one example, the first gas sensor 28′ measures and observes a concentration of various gases in the incoming air, including, but not limited to, sulfur dioxide (SO₂), oxides of nitrogen (NOₓ), total hydrocarbons (HC) and ammonia (NH₃). The first gas sensor 28′ is coupled to the second side 32″ of the housing 32 so that the first gas sensor 28′ is in communication with the air entering the housing 32 via the air inlet 24.

The second gas sensor 28″ measures and observes gases exiting the air filter 30 and generates sensor signals based thereon. Generally, the second gas sensor 28″ measures and observes the presence of chemical gases in the air. In one example, the second gas sensor 28″ measures and observes a concentration of various gases in the gases exiting the air filter 30, including, but not limited to, sulfur dioxide (SO₂), oxides of nitrogen (NOₓ), total hydrocarbons (HC) and ammonia (NH₃). The second gas sensor 28″ is coupled to the first side 32′ of the housing 32 so that the second gas sensor 28″ is in communication with the gas exiting the housing 32 through the gas outlet 26. The mass flow sensor 28′ measures and observes conditions of the gas exiting the air filter 30 and generates sensor signals based thereon, which are communicated to the module 22. Generally, the mass flow sensor 28′ measures and observes a mass of the gas flow through the gas outlet 26, along with a temperature of the gas and a flow rate of the gas. In one example, the mass flow sensor 28′ also measures and observes a relative humidity of the gas.

The air filter 30 is disposed in the housing 32 and serves to divide the housing 32 into the first side 32′ and the second side 32″. The air filter 30 comprises any suitable filter having an adsorptive material that filters out or removes contaminants from the incoming air that are harmful to the powertrain 14, for example, the air filter 30 comprises any suitable filter having an adsorptive material that filters out or removes contaminants from the incoming air that are harmful to a fuel cell stack 34 of the powertrain 14, including, but not limited to sulfur dioxide (SO₂), oxides of nitrogen (NOₓ), total hydrocarbons (HC) and ammonia (NH₃), salts and dust. Thus, in this example, the air filter 30 is an air filter for use with a fuel cell system, which includes a fuel cell stack 34. Generally, as will be discussed further herein, the chemical capacity or adsorption capability of the air filter 30 is known, but the air quality or concentration of gases through which the vehicle 10 is operating is unknown. By providing improved systems and methods for calculating the life of the air filter 30, the replacement of the air filter 30 can be performed when necessary and prior to an undesirable concentration of contaminants reaching the powertrain 14.

The powertrain 14 receives the gas from the gas outlet 26. The powertrain 14 includes a propulsion device, which supplies power to a driveline. In one example, the propulsion device comprises the fuel cell stack 34, which through a chemical reaction generates at least electrical energy, as known to one skilled in the art. The transmission transfers the power from the powertrain 14 to a suitable driveline coupled to one or more wheels (and tires) of the vehicle 10 to enable the vehicle 10 to move. It should be noted that although the vehicle 10 is illustrated herein as including a fuel cell stack 34, the vehicle 10 can include other propulsion devices, if desired. In this example, the powertrain 14 also includes a compressor 36, which is in communication with the gas outlet 26. The compressor 36 is also in communication with the module 22 over a suitable communication architecture or arrangement that facilitates transfer of data, commands, power, etc. The compressor 36 compresses the gas from the gas outlet 26 and delivers the compressed gas to the fuel cell stack 34. The fuel cell stack 34 uses oxygen from the compressed gas along with another reactant, such as hydrogen, to generate electrical energy, which is provided to the driveline. It should be noted that while the air filter 30 and module 22 are described and illustrated herein as being associated with the vehicle 10, the air filter 30 and module 22 can be used with any suitable fuel cell system such as a stationary fuel cell, a fuel cell for use in mobile platforms, such as buses, trains, ships and airplanes. Thus, the use of the air filter 30 and the module 22 in the vehicle 10 is merely exemplary.

The notification system 16 is in communication with the module 22, over a suitable communication architecture, to supply one or more notifications (notification data) regarding the air filter 30 to an occupant of the vehicle 10. In one example, the notification system 16 comprises part of an instrument cluster, and includes a display device. Generally, the notification system 16 comprises a display device, which displays a message to an occupant of the vehicle 10 regarding a condition of the air filter 30. Alternatively, the notification system 16 can include a lamp or warning indicator, which is located on the instrument cluster. The notification system 16 can also be a part of the infotainment center. It should be understood that these examples are merely exemplary, as the notification regarding the air filter 30 can be provided through any suitable device, such as a haptic warning, audio warning message, etc.

The telecommunication system 18 comprises any suitable system for receiving data from and communicating data to a remote station 38. In one example, the remote station 38 is a remote computing system that is communicatively coupled to a remote datastore 40. Alternatively, the remote station 38 can comprise a remote call service and diagnostic center, such as OnStar, LLC. In one example, based on the receipt of data from the telecommunication system 18, the remote station 38 queries the remote datastore 40 to obtain monitored air quality data based on the data received from the telecommunication system 18. The telecommunication system 18 is in communication with the module 22 over a suitable communication architecture or arrangement that facilitates transfer of data, commands, power, etc.

In one example, the telecommunication system 18 can include a radio configured to receive data transmitted by modulating a radio frequency (RF) signal from the remote station 38 as is well known to those skilled in the art. For example, the remote station 38 may be part of a cellular telephone network and the data may be transmitted according to the long-term evolution (LTE) standard. The telecommunication system 18 transmits data to the remote station 38 to achieve bi-directional communications. However, other techniques for transmitting and receiving data may alternately be utilized. For example, the telecommunication system 18 may achieve bi-directional communications with the remote station 38 over Bluetooth or by utilizing a Wi-Fi standard, i.e., one or more of the 802.11 standards as defined by the Institute of Electrical and Electronics Engineers (“IEEE”), as is well known to those skilled in the art. The telecommunication system 18 may be separate from or integral with an infotainment system. In addition, the telecommunication system 18 may be configured to encode data or generate encoded data. The encoded data generated by the telecommunication system 18 may be encrypted. A security key may be utilized to decrypt and decode the encoded data, as is appreciated by those skilled in the art. The security key may be a “password” or other arrangement of data that permits the encoded data to be decrypted. Alternatively, the remote station 38 may implement security protocols to ensure that communication takes place with the appropriate vehicle 10.

The remote datastore 40 stores one or more tables (e.g., lookup tables) that indicate a monitored air quality (e.g. average air pollution for chemical gases) based on position coordinates of the vehicle 10 from the GPS system 20. In other words, the remote datastore 40 stores one or more tables that provide monitored pollution values for chemical gases based on known pollution levels in certain geographical locations. In one example, the one or more tables are populated based on monitoring data obtained from Environmental Protection Agency (EPA) monitoring locations. Generally, the EPA monitoring locations can generate substantially real-time air quality data, but the monitored air quality data can also comprise air quality data that is measured and observed by EPA monitoring locations at various time intervals, including, but not limited to, a one hour sampling rate, eight hour sampling rate, 24 hour sampling rate, monthly sampling rate, etc. In addition, the monitored air quality data can be averaged air quality data given the sampling rate. In various embodiments, the tables can be interpolation tables that are defined by one or more indexes. The monitored air quality data provided by at least one of the tables indicates a pollution value for chemical gases, such as a concentration of sulfur dioxide (SO₂), oxides of nitrogen (NOₓ), total hydrocarbons (HC) and ammonia (NH₃) in parts per billion (ppb), based on the position coordinates of the vehicle 10. As an example, one or more tables can be indexed by parameters such as, but not limited to, geographical or position coordinates, to provide the monitored air quality data. Thus, the monitored air quality data indicates a pollution value for chemical gases, such as a concentration of sulfur dioxide (SO₂), oxides of nitrogen (NOₓ), total hydrocarbons (HC) and ammonia (NH₃) in parts per billion (ppb), based on a particular position coordinates provided by the GPS system 20. It should be noted that the units used herein are merely exemplary, as for example, the chemical gas concentration can be expressed in units other than parts per billion, such as parts per million or in units of mass per unit volume.

The GPS system 20 includes a GPS receiver, which is in communication with the module 22 over a suitable communication architecture or arrangement that facilitates transfer of data, commands, power, etc. As is known to one skilled in the art, the GPS receiver receives one or more signals from GPS satellites to determine a position coordinates (latitude and longitude) of the vehicle 10 and can also include a traffic density and/or traffic speed surrounding the vehicle 10. As will be discussed herein, the position coordinates of the vehicle 10 are transmitted by the telecommunication system 18 to the remote station 38. Based on the position coordinates, the remote station 38 queries the remote datastore 40 for monitored air quality information and the remote station 38 transmits the monitored air quality information to the vehicle 10. Alternatively, as will be discussed in greater detail herein, if a connection to the remote station 38 is unavailable, the module 22 can obtain default values for the air quality information based on the position coordinates.

In various embodiments, the module 22 outputs notification data to the notification system 16 based on one or more of the sensor signals and further based on the fuel cell air filter life prediction systems and methods of the present disclosure to notify an occupant of the vehicle 10 of the remaining life or remaining capacity of the air filter 30. As will be discussed, the module 22 outputs notification data for display by the notification system 16 to notify the occupant based on the sensor signals from the at least one sensor 28, or outputs notification data for display by the notification system 16 to notify the occupant based on the sensor signals from the at least one sensor 28 and based on data obtained from the remote datastore 40 given the position coordinates of the vehicle 10 from the GPS system 20.

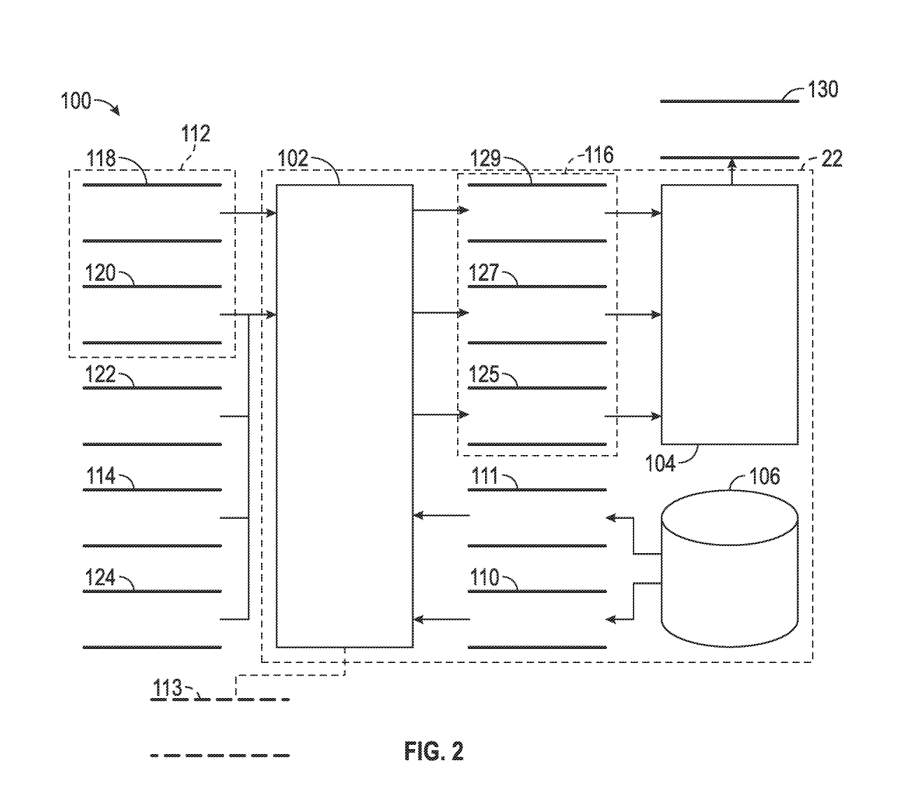

Referring now to FIG. 2, and with continued reference to FIG. 1, a dataflow diagram illustrates various embodiments of a filter monitoring system 100 for the air filter 30 (FIG. 1) that may be embedded within the module 22. Various embodiments of the filter monitoring system according to the present disclosure can include any number of sub-modules embedded within the module 22. As can be appreciated, the sub-modules shown in FIG. 2 can be combined and/or further partitioned to similarly monitor the air filter 30 and output notification data based on the signals from the at least one sensor 28 and based on data obtained from the remote datastore 40 given the position coordinates of the vehicle 10 from the GPS system 20 (FIG. 1). Inputs to the system can be sensed from the vehicle 10 (FIG. 1), received from other control modules (not shown), and/or determined/modeled by other sub-modules (not shown) within the module 22. In various embodiments, the module 22 includes a filter monitor module 102, a notification module 104 and a tables datastore 106.

The tables datastore 106 stores one or more tables (e.g., lookup tables) that indicate an air quality (e.g. average air pollution for chemical gases) based on GPS data 114 from the GPS system 20. In other words, the tables datastore 106 stores one or more tables that provide pollution values for chemical gases based on known pollution levels in certain geographical locations. In one example, the one or more tables store data obtained from the Environmental Protection Agency (EPA). In various embodiments, the tables can be interpolation tables that are defined by one or more indexes. An air quality value 110 provided by at least one of the tables indicates a pollution value for chemical gases, such as a concentration of sulfur dioxide (SO₂), oxides of nitrogen (NOₓ), total hydrocarbons (HC) and ammonia (NH₃) in parts per billion (ppb), based on the position coordinates of the vehicle 10 from the GPS data 114. As an example, one or more tables can be indexed by parameters such as, but not limited to, geographical or position coordinates, to provide the air quality value 110. Thus, the air quality value 110 indicates a pollution value for chemical gases, such as a concentration of sulfur dioxide (SO₂), oxides of nitrogen (NOₓ), total hydrocarbons (HC) and ammonia (NH₃) in parts per billion (ppb), based on the GPS data 114 provided by the GPS system 20. It should be noted that the units used herein are merely exemplary, as for example, the chemical gas concentration can be expressed in units other than parts per billion.

In various embodiments, the tables datastore 106 stores one or more tables (e.g., lookup tables) that indicate a correction value based on the conditions observed and measured by the mass flow sensor 28′″, based on the traffic density and/or traffic speed from the GPS system 20 and based on the design of the air filter 30. In other words, the tables datastore 106 also stores one or more tables that provide correction values for the adsorption of the air filter 30 based on conditions observed and measured by the mass flow sensor 28′″ during the operation of the vehicle 10, along with one or more tables that provide correction values for the adsorption of the air filter 30 based on traffic conditions surrounding the vehicle 10 during the operation of the vehicle 10 and one or more tables that provide correction values for the adsorption of the air filter 30 based the design of the air filter 30 itself. Thus, the correction value accounts for operational and environmental conditions that affect the chemical gas adsorption performance of the air filter 30.

In one example, the one or more tables store correction values based on known conditions that affect the adsorption of the air filter 30. For example, the flow rate of the contaminated air through the air filter 30 can affect the chemical gas adsorption performance of the air filter 30. For example, a high flow rate based on the mass air flow sensor data 122 would result in a decreased residence time of the contaminant in the air filter 30, potentially decreasing the gas adsorption capacity. As a further example, relative humidity may affect the adsorption characteristics of the adsorbent material used in the air filter 30. For example, at high relative humidity the chemical gas and water molecules can compete for adsorption sites on the adsorbent media of the air filter 30. Alternatively at high humidity certain catalytic or chemical gas adsorbent materials may have an increased capacity to remove certain chemical gas species from the contaminated airstream.

The ambient temperature can affect the adsorption characteristics of the adsorbent material used in the air filter 30. For example, the kinetic energy of the gas molecule increases with increasing temperature. This may cause a reduction in the adsorption capacity of the adsorbent material of the air filter 30 with increasing temperature for physically adsorbed gases. Alternatively, certain catalytic or chemical gas adsorbent materials may have an increased capacity to remove certain chemical gas species from the contaminated airstream at higher temperatures.

Traffic density and/or traffic speed can also affect the adsorption characteristics of the adsorbent material used in the air filter 30. The traffic density and/or traffic speed can be obtained from the GPS system 20. For example, tailpipe emissions in slow moving, congested traffic can result in higher than expected concentrations of chemical gases entering the air inlet 24 of the air filter system 12. This may cause a reduction in the gas filtration performance of the adsorbent material of the air filter 30. In addition, the design of the air filter 30 can affect the adsorption characteristics of the adsorbent material used in the air filter 30. For example the gas adsorption capacity of the adsorbent material may be affected by the available surface area or volume of the air filter 30.

In various embodiments, the tables can be interpolation tables that are defined by one or more indexes. An correction value 111 provided by at least one of the tables indicates a correction value for determining the remaining life of the air filter 30 based on the temperature, relative humidity, mass flow rate, traffic density, traffic speed and design of the air filter 30. As an example, one or more tables can be indexed by parameters such as, but not limited to, temperature, relative humidity, mass flow rate, traffic density, traffic speed and air filter design, to provide the correction value 111. Thus, the correction value 111 indicates a correction factor for the performance of the air filter 30, based on operational or environmental conditions. In addition, it should be noted that the tables stored in the tables datastore 106 can be updated with data received by the telecommunications system 18, if desired.

The filter monitor module 102 receives as input sensor data 112 from the at least one sensor 28 and GPS data 114 from the GPS system 20. The GPS data 114 indicates the position coordinates or geographical location of the vehicle 10 and the traffic density and/or traffic speed surrounding the vehicle 10. The sensor data 112 indicates one or more concentrations of gases, including, but not limited to, sulfur dioxide (SO₂), oxides of nitrogen (NOₓ), total hydrocarbons (HC) and ammonia (NH₃), in the air filter system 12 observed and measured by one or more of the first gas sensor 28′ and second gas sensor 28″. The filter monitor module 102 sets a notification 116 for the notification module 104 based on at least one of the sensor data 112 and GPS data 114.

In various embodiments, the filter monitor module 102 receives first gas sensor data 118 from the first gas sensor 28′, second gas sensor data 120 from the second gas sensor 28″ and mass air flow sensor data 122 from the mass flow sensor 28′″ over a time interval (i). The first gas sensor data 118 indicates one or more concentrations of gases, including, but not limited to, sulfur dioxide (SO₂), oxides of nitrogen (NOₓ), total hydrocarbons (HC) and ammonia (NH₃), observed and measured by the first gas sensor 28′. The second gas sensor data 120 indicates one or more concentrations of gases, including, but not limited to, sulfur dioxide (SO₂), oxides of nitrogen (NOₓ), total hydrocarbons (HC) and ammonia (NH₃), observed and measured by the second gas sensor 28″. Optionally, the filter monitor module 102 also receives as input compressor data 124 from the compressor 36. The compressor data 124 indicates if the compressor 36 is on or off. Based on the GPS data 114, the first gas sensor data 118, the second gas sensor data 120, the mass air flow sensor data 122 and the compressor data 124, the filter monitor module 102 determines pollution data 125, efficiency data 127 and life data 129 and sets the pollution data 125, efficiency data 127 and life data 129 for the notification module 104. It should be noted that the use of compressor data 124 is merely exemplary, and the filter monitor module 102 can determine the pollution data 125, efficiency data 127 and life data 129 based on other data that indicates that the fuel cell stack 34 is operating.

In one example, the filter monitor module 102 determines a chemical gas breakthrough or pollution data 125 based on the first gas sensor data 118 or the second gas sensor data 120. The pollution data 125 indicates that a chemical gas concentration observed by the first gas sensor 28′ or the second gas sensor 28″ is greater than a predefined threshold based on the first gas sensor data 118 or the second gas sensor data 120. The predefined threshold is generally the maximum allowable concentration of the contaminant gas the fuel cell stack 34 can be exposed to. Thus, the predefined threshold is defined for each contaminant gas and based on the material and configuration of the air filter 30, the materials and configuration of the fuel cell stack 34 and the compressor 36. In one example, the predefined threshold is about 10 parts per billion (ppb) to about 1000 parts per million (ppm). The filter monitor module 102 sets the pollution data 125 for the notification module 104.

In various embodiments, the filter monitor module 102 determines a filter efficiency for the air filter 30 or efficiency data 127 based on the first gas sensor data 118 and the second gas sensor data 120. In one example, the filter monitor module 102 determines the instantaneous filter efficiency based on the following equation:

$${E}_{inst .} = \frac{{C}_{ppb 1} - {C}_{ppb 2}}{{C}_{ppb 1}} * 100 \% \qquad ( 1 )$$

Wherein is the instantaneous efficiency of the air filter 30 for a chemical gas of interest; C_{ppb1} is the chemical gas concentration observed and measured by the first gas sensor 28′ (first gas sensor data 118) for a particular chemical gas in parts per billion (ppb); and C_{ppb2} is the chemical gas concentration observed and measured by the second gas sensor 28″ (second gas sensor data 120) for a particular chemical gas in parts per billion (ppb). It should be noted that the units used herein are merely exemplary, as for example, the chemical gas concentration can be expressed in units other than parts per billion. Further, this equation is for a single chemical gas of interest, and thus, the filter monitor module 102 repeats the calculation of the instantaneous efficiency of the air filter 30 for all of the chemical gases of interest, including, but not limited to sulfur dioxide (SO₂), oxides of nitrogen (NOₓ), total hydrocarbons (HC) and ammonia (NH₃), based on the above equation.

The filter monitor module 102 sets the determined instantaneous efficiency for the chemical gas of interest as the efficiency data 127 for the notification module 104.

In order to determine a remaining filter life for the air filter 30 or life data 129, the filter monitor module 102 determines an averaged chemical gas concentration over a time interval (i) based on the following equation:

$$\overline{{C}_{ppb}} = \frac{1}{N} {\sum }_{i = 1}^{N} {C}_{ppb 1 , i} \qquad ( 2 )$$

Wherein C̅_̅{̅p̅p̅b̅}̅ is the averaged chemical gas concentration expressed in parts per billion (ppb); N is the total number of C_{ppb1} measurements; i is the time interval; and C_{ppb1} is the concentration of the particular contaminant gas expressed in parts per billion from the first gas sensor data 118. It should be noted that while it is described herein as calculating an averaged chemical gas concentration for the determination of the remaining filter life for the air filter 30, the filter monitor module 102 can determine the remaining filter life for the air filter 30 based on a single concentration measurement of the particular chemical gas. Thus, the equations contained herein are merely exemplary.

The filter monitor module 102 determines a cumulative mass of the air from the mass air flow sensor data 122 over the time interval (i) based on the following equation:

mᵢ=∫ₜ_{₁}^{t}^{₂}\dot{m}dt (3)

Wherein, mᵢ is the mass of the air in kilograms (kg) observed and measured by the mass flow sensor 28′″ during the time interval (i); t₁ is a start time of the time interval (i); t₂ is an end time of the time interval (i); and rim is the mass air flow in kilograms per second (kg/s) from the mass air flow sensor data 122.

The filter monitor module 102 can also determine a total mass of air based on the following equation:

m=Σᵢ₌₁^{N}mᵢ (4)

Wherein m is the total mass of air in kilograms (kg); N is the total number of mᵢ measurements; and mᵢ is the cumulative mass of the air in kilograms (kg) observed and measured by the mass flow sensor 28′″ over the time interval (i). In one embodiment, the total mass of air can be used to arrive at a course estimate for the amount of contaminant gas present.

The filter monitor module 102 determines if a correction factor α is required based on the efficiency of the air filter 30. The filter monitor module 102 determines that the correction factor α is required when the instantaneous efficiency of the air filter 30 is less than a predefined threshold, such as about 100%. In one example, the filter monitor module 102 determines the correction factor α based on the following equation:

$$α = \frac{{C}_{ppb 1} - {C}_{ppb 2}}{{C}_{ppb 1}} \qquad ( 5 )$$

Wherein α is the correction factor (no units), C_{ppb1} is the chemical gas concentration observed and measured by the first gas sensor 28′ (first gas sensor data 118) in parts per billion (ppb) for a particular chemical gas; and C_{ppb2} is the chemical gas concentration observed and measured by the second gas sensor 28″ (second gas sensor data 120) for a particular chemical gas in parts per billion (ppb).

The filter monitor module 102 determines a corrected cumulative mass of a particular chemical gas or contaminant of interest over the time interval based on the following equation:

$${M}_{C , i} = \frac{{ρ}_{c}}{{ρ}_{air}} * \frac{\overline{{C}_{ppb}}}{1 \times {10}^{9}} * α * {m}_{i} \qquad ( 6 )$$

Wherein M_{C,i} is the corrected cumulative mass of contaminant of interest over time interval, i, in kilograms (kg); ρ_{c} is the density of the contaminant gas in kilograms per meter cubed (kg/m³); ρₐᵢᵣ is the density of the air, C̅_̅{̅p̅p̅b̅}̅ is the averaged chemical gas concentration expressed in parts per billion (ppb); a is the correction factor (no units); and mᵢ is the cumulative mass of air over the time interval (i) in kilograms (kg).

The density of the air and the contaminant gas are determined using the following equation:

$$ρ = \frac{PM}{RT} \qquad ( 7 )$$

Wherein ρ is the density of the gas in kilograms per meter cubed (kg/m³), P is the pressure in Pascal (Pa), M is the molar mass of the gas in kilograms per mol (kg/mol), R is the gas constant in Joules per mol Kelvin (J/mol K) and T is the temperature in Kelvin (K). The temperature is observed and measured by the mass flow sensor 28′″.

Alternatively, if relative humidity data is available from the mass air flow sensor data 122, the density of the air and the contaminant gas can be calculated based on the following equation:

$${ρ}_{h} = \frac{{P}_{d} {M}_{d} + {P}_{v} {M}_{v}}{RT} \qquad ( 8 )$$

Wherein ρₕ is the density of humid air; P_{d} is the partial pressure of dry air; Pᵥ is the partial pressure of water vapor; Md is the molar mass of dry air; Mv is the molar mass of water vapor; and Pᵥ=φPₛₐₜ, where Pₛₐₜ is saturated water vapor pressure and φ is the relative humidity from the mass air flow sensor data 122. In addition, it should be noted that if the ratio of the contaminant gas density to air density is calculated at the same pressure, same humidity and same temperature, it would be substantially equivalent to the ratio of the molar masses between the contaminant gas and the air.

The filter monitor module 102 sums the corrected cumulative mass for the contaminant or chemical gas of interest to arrive at a total mass of the contaminant or chemical gas of interest based on the following equation:

M_{C}=Σᵢ₌₁^{N}M_{C,i} (9)

Wherein M_{C} is the total mass of the contaminant or chemical gas of interest in kilograms (kg); N is the number of M_{C,i} measurements; and M_{C,i} is the corrected cumulative mass of contaminant of interest over a time interval (i) in kilograms (kg).

The filter monitor module 102 determines the percentage of the remaining life of the air filter 30 based on the following equation:

$${t}_{filter} = ( 1 - \frac{{M}_{C}}{{M}_{cap .}} ) * 100 \qquad ( 10 )$$

Wherein t_{filter} is the remaining percentage of life of the air filter 30; M_{cap} is the capacity of the air filter 30 for the chemical gas of interest (determined from experimental testing) in kilograms (kg); and M_{C} is the total mass of the contaminant or chemical gas of interest in kilograms (kg).

The filter monitor module 102 determines the remaining percentage of life of the air filter 30 for each of the contaminant or chemical gases of interest. The filter monitor module 102 selects the lowest remaining percentage of life of the air filter 30 and compares this value to a maximum filter usage life and a remaining percentage of life of the air filter 30 based on particulates and dust encountered by the air filter 30. The filter monitor module 102 selects the lowest percentage of life of these values and sets this value as the life data 129 for the notification module 104. It should be noted that determination of the remaining percentage of life of the air filter 30 based on particulates and dust encountered by the air filter 30 is discussed in U.S. Pat. No. 8,626,426, which is incorporated herein by reference.

In various embodiments, the filter monitor module 102 determines the remaining percentage of life of the air filter 30 or the life data 129 based on the first gas sensor data 118, the mass air flow sensor data 122, GPS data 114 and the compressor data 124. It should be noted that the use of compressor data 124 is merely exemplary, and the filter monitor module 102 can determine the life data 129 based on other data that indicates that the fuel cell stack 34 is operating. In this example, the filter monitor module 102 determines the average chemical gas concentration for a particular chemical gas of interest using equation (2) from above. The filter monitor module 102 determines the cumulative mass of air over the time interval using equation (3), above, and the total mass of air using equation (4) from above.

The filter monitor module 102 determines if the correction value 111 is required for determining the remaining filter life of the air filter 30 based on the GPS data 114 and mass air flow sensor data 122. If the correction value 111 is required, the filter monitor module 102 retrieves the correction value 111 from the tables datastore 106 and calculates a corrected cumulative mass of a contaminant in the time interval based on the following equation:

$${M}_{C , i} = \frac{{ρ}_{c}}{{ρ}_{air}} * \frac{\overline{{C}_{ppb}}}{1 \times {10}^{9}} * K * {m}_{i} \qquad ( 11 )$$

Wherein M_{C,i} is the corrected cumulative mass of the chemical gas of interest over the time interval (i) in kilograms (kg), ρ_{c} is the density of the contaminant gas in kilograms per meter cubed (kg/m³), ρₐᵢᵣ is the density of the air, C̅_̅{̅p̅p̅b̅}̅ is the averaged chemical gas concentration expressed in parts per billion (ppb); K is the correction value 111; and mᵢ is the cumulative mass of air over the time interval (i) in kilograms (kg). The density of the air and the contaminant gas are determined using equation (7) or equation (8), above.

The filter monitor module 102 sums the corrected cumulative mass for the contaminant or chemical gas of interest to arrive at a total mass of the contaminant of interest based on equation (9), above. The filter monitor module 102 determines the remaining percentage of life of the air filter 30 based on equation (10), above. The filter monitor module 102 determines the remaining percentage of life of the air filter 30 for each of the contaminant or chemical gases of interest and selects the lowest remaining percentage of life of the air filter 30 and compares this value to a maximum filter usage life and a remaining percentage of life of the air filter 30 based on particulates and dust encountered by the air filter 30. The filter monitor module 102 selects the lowest percentage of life of these values and sets this value as the life data 129 for the notification module 104.

In various embodiments, the filter monitor module 102 receives air quality data 113 as input from the telecommunication system 18. The air quality data 113 indicates a monitored pollution value for chemical gases, such as a concentration of sulfur dioxide (SO₂), oxides of nitrogen (NOₓ), total hydrocarbons (HC) and ammonia (NH₃) in parts per billion (ppb), based on the position coordinates of the vehicle 10 as communicated by the telecommunication system 18 to the remote station 38 (FIG. 1). Based on the air quality data 113, GPS data 114, mass air flow sensor data 122 and the compressor data 124, the filter monitor module 102 determines a remaining percentage of life of the air filter 30 or life data 129. It should be noted that the use of compressor data 124 is merely exemplary, and the filter monitor module 102 can determine the life data 129 based on other data that indicates that the fuel cell stack 34 is operating.

In this example, the filter monitor module 102 determines the cumulative mass of the air over the time interval using equation (3), above, and determines the total mass of the air using equation (4), above. The filter monitor module 102 determines if the correction value 111 is required for determining the remaining filter life of the air filter 30 based on the GPS data 114 and mass air flow sensor data 122. If the correction value 111 is required, the filter monitor module 102 retrieves the correction value 111 from the tables datastore 106 and calculates a corrected cumulative mass of a contaminant in a time interval based on the following equation:

$${M}_{C , i} = \frac{{ρ}_{c}}{{ρ}_{air}} * \frac{{C}_{ppb}}{1 \times {10}^{9}} * K * {m}_{i} \qquad ( 12 )$$

Wherein M_{C,i} is the corrected cumulative mass of the chemical gas of interest over time interval (i) in kilograms (kg), ρ_{c} is the density of the contaminant gas in kilograms per meter cubed (kg/m³), ρₐᵢᵣ is the density of the air, C_{ppb} is the chemical gas concentration expressed in parts per billion (ppb) from the monitored air quality data 113; K is the correction value 111; and mᵢ is the cumulative mass of air over the time interval (i) in kilograms (kg). The density of the air and the contaminant gas are determined using equation (7) or equation (8), above. If no correction value 111 is required, then K is equal to one.

The filter monitor module 102 sums the corrected cumulative mass for the contaminant or chemical gas of interest to arrive at a total mass of the contaminant of interest based on equation (9), above. The filter monitor module 102 determines the remaining percentage of life of the air filter 30 based on equation (10), above. The filter monitor module 102 determines the remaining percentage of life of the air filter 30 for each of the contaminant or chemical gases of interest and selects the lowest remaining percentage of life of the air filter 30 and compares this value to a maximum filter usage life and a remaining percentage of life of the air filter 30 based on particulates and dust encountered by the air filter 30. The filter monitor module 102 selects the lowest percentage of life of these values and sets this value as the life data 129 for the notification module 104.

The notification module 104 receives the pollution data 125, the efficiency data 127 and the life data 129 as input. Based on the pollution data 125, the efficiency data 127 and the life data 129, the notification module 104 outputs notification data 130 to the notification system 16. The notification data 130 comprises a signal or a warning message for the notification system 16 based on at least one of the pollution data 125, the efficiency data 127 and the life data 129. In one example, based on the pollution data 125, the notification data 130 comprises a warning message that the vehicle 10 is operating in high pollution. In another example, based on the efficiency data 127, the notification data 130 comprises a warning message for the operator of the vehicle 10 to check the air filter 30. In one example, based on the life data 129, the notification module 104 outputs notification data 130 that indicates to the operator of the vehicle 10 that service is needed for the air filter 30 if the percentage of life is less than a predefined threshold percentage, such as about 15%. For example, the notification data 130 can provide a message to change the air filter 30 or a message to change the air filter 30 at a next service appointment. Further, in one example, based on the life data 129, the notification module 104 outputs notification data 130 that indicates to the percentage of life of the air filter 30.

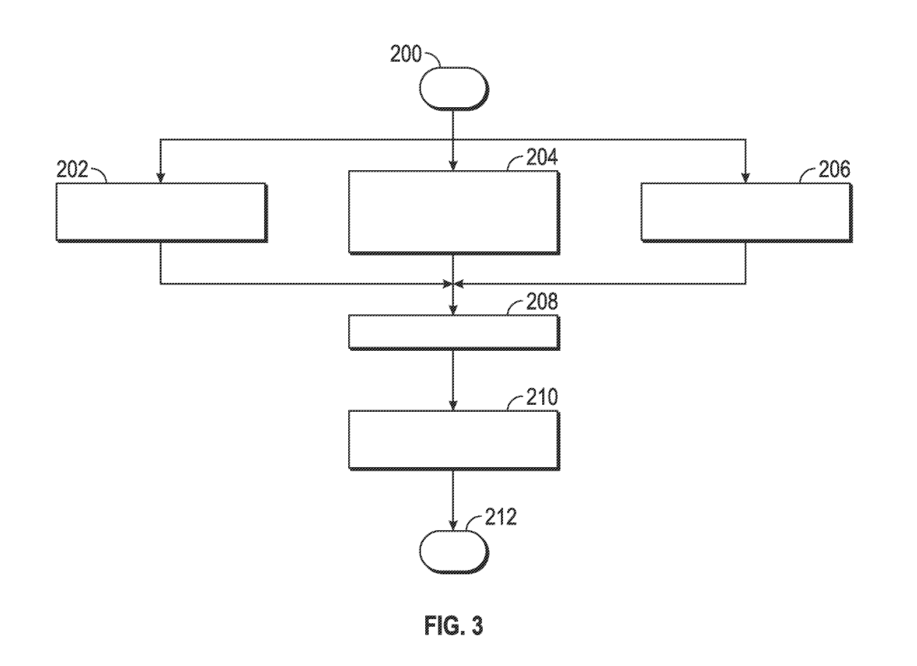

Referring now to FIGS. 3-7, and with continued reference to FIGS. 1 and 2, flowcharts illustrate a control method that can be performed by the module 22 of FIG. 1 in accordance with the present disclosure. As can be appreciated in light of the disclosure, the order of operation within the method is not limited to the sequential execution as illustrated in FIGS. 3-7, but may be performed in one or more varying orders as applicable and in accordance with the present disclosure.

In various embodiments, the method can be scheduled to run based on predetermined events, and/or can run continually during operation of the vehicle 10.

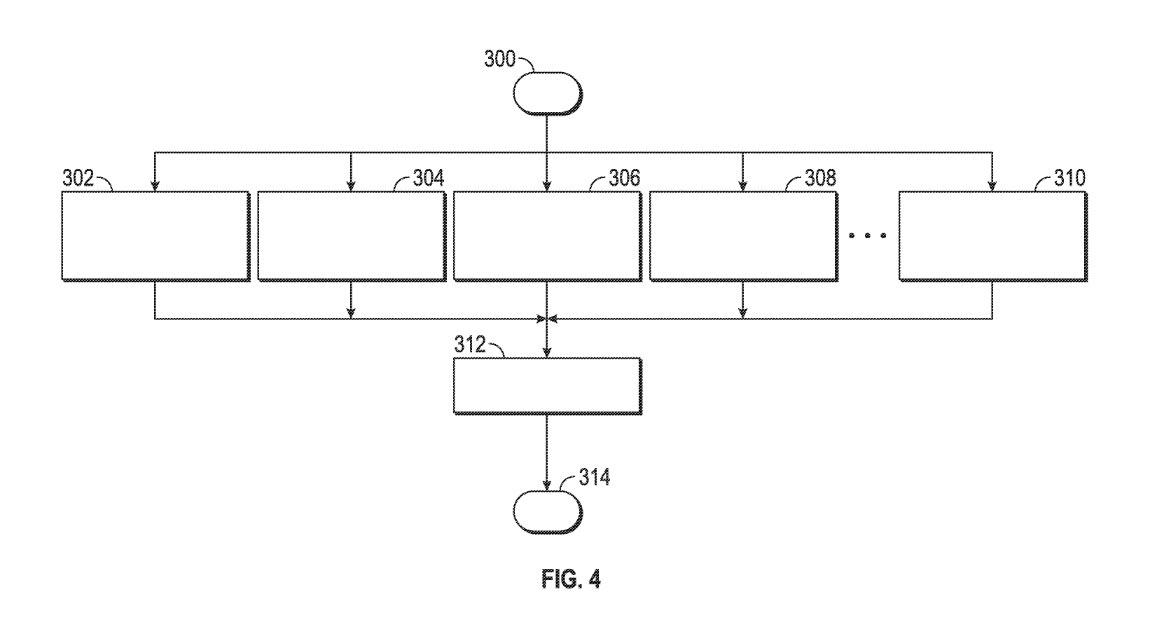

With reference to FIG. 3, the method begins at 200. At 202, the method determines the percentage of life remaining for the air filter 30 based on the chemical gases experienced by the air filter (FIG. 4). At 204, the method determines the percentage of life remaining for the air filter 30 based on the particulates and/or dust experienced by the air filter 30 as discussed in U.S. Pat. No. 8,626,426, which is incorporated herein by reference. At 206, the method determines a maximum filter usage life remaining (the usage of the air filter 30 is limited a predefined number of years, such as about 1 year to about 4 years based on the materials employed in the air filter 30 and the usage environment). It should be noted that while 202, 204 and 206 are illustrated herein as being performed substantially simultaneously, 202, 204 and 206 can be formed sequentially.

At 208, the method determines the lowest percentage of life remaining for the air filter 30 based on the values determined in 202, 204 and 206 and sets this as the life data 129. At 210, the method outputs the percentage of life remaining for the air filter 30 as the notification data 130 for the notification system 16. The method ends at 212.

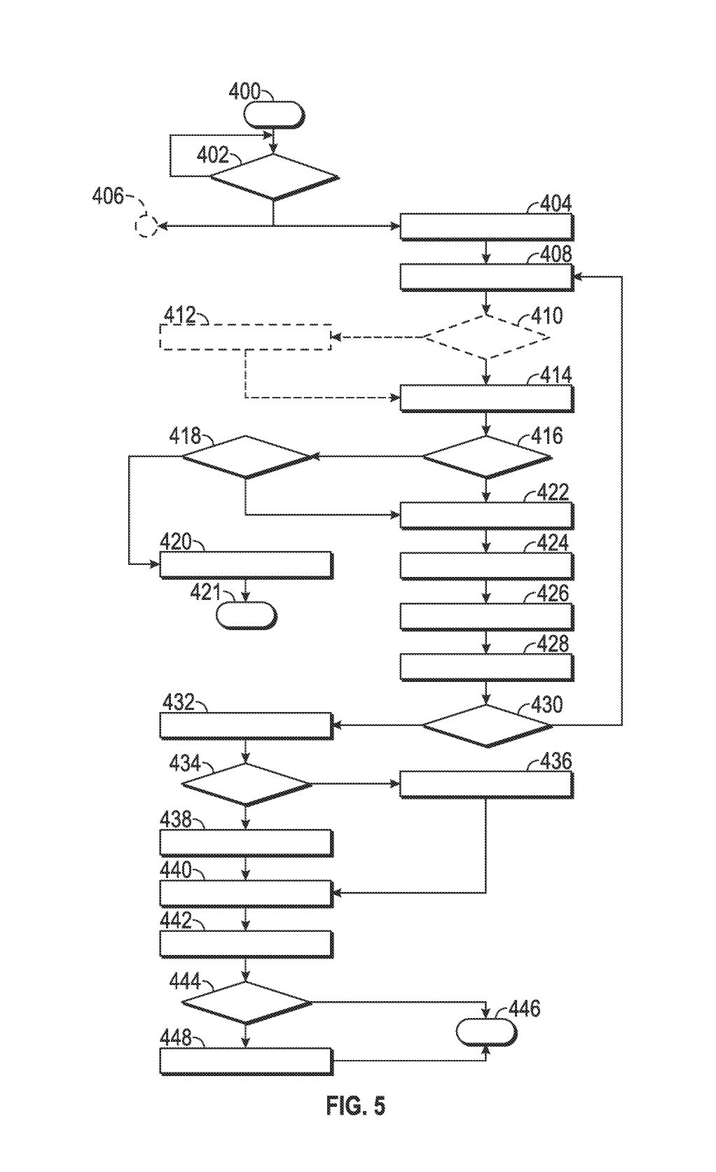

With reference to FIG. 4, a method of calculating the percentage of life remaining for the air filter 30 based on the chemical gases experienced by the air filter is shown. The method starts at 300. At 302, the method determines a percentage of life remaining for the air filter 30 based on a first chemical gas of interest, such as sulfur dioxide (SO₂). At 304, the method calculates a percentage of life remaining for the air filter 30 based on a second chemical gas of interest, such as oxides of nitrogen (NOₓ). At 306, the method determines a percentage of life remaining for the air filter 30 based on a third chemical gas of interest, such as total hydrocarbons (HC). At 308, the method determines a percentage of life remaining for the air filter 30 based on a fourth chemical gas of interest, such as ammonia (NH₃). At 310, the method determines a percentage of life remaining for the air filter 30 based on an n^{th} chemical gas of interest. The method determines the percentage of life remaining for the air filter 30 based on the chemical gases of interest using one or more of the methods described with regard to FIGS. 5-7, below. It should be noted that while 302, 304, 306, 308 and 310 are illustrated herein as being performed substantially simultaneously, 302, 304, 306, 308 and 310 can be formed sequentially.

At 312, the method determines the lowest percentage of life remaining for the air filter 30 based on the values determined in 302, 304, 306, 308 and 310 as individual values or as a summation of the values. The method uses this value as the percentage of life remaining for the air filter 30 based on the chemical gases experienced by the air filter at 202 of FIG. 3. The method ends at 314.

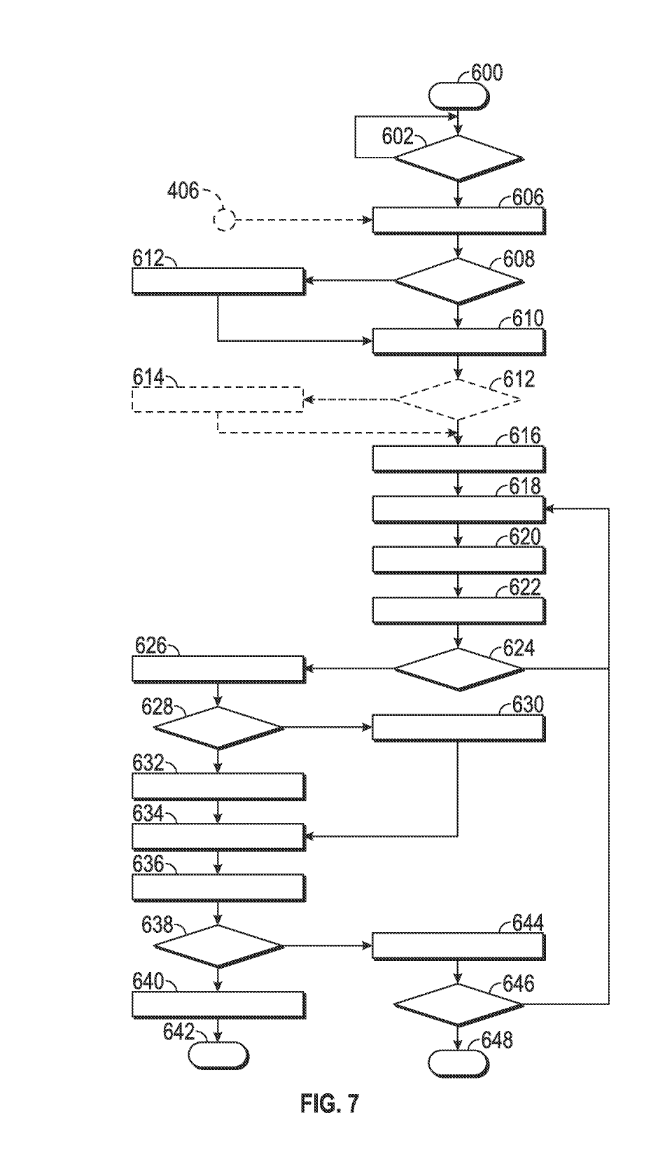

With reference to FIG. 5, in one embodiment, a method for determining a percentage of life remaining for the air filter 30 based on a chemical gas of interest is shown. The method starts at 400. At 402, the method determines if the compressor 36 is running based on the compressor data 124 (FIG. 2). If the compressor 36 is running, the method goes to 404 and, optionally, goes to 406 of FIG. 7. Otherwise, the method loops. It should be noted that the use of the compressor data 124 is merely exemplary, and the method can run based on other events, such as an ignition on event.

At 404, the method sets a timer as a start time (t₁) for the time interval (i). At 408, the method receives the first gas sensor data 118 and the second gas sensor data 120 as input. Optionally, at 410, the method determines if the chemical gas concentration for the particular gas of interest is greater than a predefined threshold value (pollution data 125). The predefined threshold is generally the maximum allowable concentration of the contaminant gas the fuel cell stack 34 can be exposed to. Thus, the predefined threshold is defined for each contaminant gas and based on the material and configuration of the air filter 30, the fuel cell stack 34 and the compressor 36. In one example, the predefined threshold is about 10 parts per billion (ppb) to about 1000 parts per million (ppm). If the chemical gas concentration for the particular gas of interest is greater than the predefined threshold value, the method outputs the notification data 130 to the notification system 16 at 412 that indicates that the vehicle 10 is operating in high pollution.

Otherwise, at 414, the method determines the instantaneous efficiency (E_{inst.}) or efficiency data 127 for the air filter 30 for the chemical gas of interest based on the first gas sensor data 118 and the second gas sensor data 120 with equation (1). At 416, the method determines if the instantaneous efficiency of the air filter 30 is greater than a predefined value, for example, about 50% to about 100%. If the instantaneous efficiency of the air filter 30 is not greater than the predefined value, the method determines if the air filter 30 passes a diagnostic test for the air filter 30 at 418. If the air filter 30 passes the diagnostic test, then the method goes to 422. Otherwise, if the air filter 30 does not pass the diagnostic test, the method outputs the notification data 130 to the notification system 16 that indicates that the air filter 30 needs service at 420. The method ends at 421.

In one example, the diagnostic test comprises determining a ratio between a number of instantaneous efficiency (E_{inst.}) values that are below the predefined value and the total number of instantaneous efficiency (E_{inst.}) values. If the ratio is greater than 0.5, the method goes to 420. If the ratio is less than 0.5, the method goes to 422.

If, at 416, the instantaneous efficiency of the air filter 30 is greater than the predefined value, at 422, the method receives the mass air flow sensor data 122 as input. At 424, the method reads the timer to define an end time (t₂) for the time interval (i). At 426, the method determines the averaged chemical gas concentration ( C̅_̅{̅p̅p̅b̅}̅) over the time interval (i) with equation (2). At 428, the method determines the cumulative mass of the air (mᵢ) from the mass air flow sensor data 122 over the time interval (i) with equation (3). At 430, the method determines if the difference between the end time (t₂) and the start time (t₁) is greater than a predefined threshold time value, such as about 25 milliseconds to about 10 minutes. If the difference between the end time (t₂) and the start time (t₁) is greater than the predefined threshold time value, the method goes to 432. Otherwise, the method loops to 408.

At 432, the method adds the cumulative mass of the air over the time interval (i) to a stored total mass of air to determine the total mass of air (equation (4)). It should be noted that 432 can be optional. At 434, the method determines if a correction factor α is required. If the correction factor α is required, the method goes to 436. At 436, the method determines the correction factor α based on equation (5) and determines the corrected cumulative mass (M_{C,i}) of the chemical gas of interest over the time interval (i) with equation (6). Otherwise, if the correction factor α is not required, the method at 438 determines the cumulative mass (M_{C,i}) of the chemical gas of interest over the time interval (i) based on the following equation:

$${M}_{C , i} = \frac{{ρ}_{c}}{{ρ}_{air}} * \frac{\overline{{C}_{ppb}}}{1 \times {10}^{9}} * {m}_{i} \qquad ( 13 )$$

Wherein M_{C,i} is the cumulative mass of the chemical gas of interest over time interval (i) in kilograms (kg), ρ_{c} is the density of the contaminant gas in kilograms per meter cubed (kg/m³), ρₐᵢᵣ is the density of the air, C̅_̅{̅p̅p̅b̅}̅ is the averaged chemical gas concentration expressed in parts per billion (ppb); and mᵢ is the cumulative mass of air over the time interval (i) in kilograms (kg). The density of the air and the contaminant gas are determined using equation (7) or equation (8), above.

At 440, the method sums the cumulative mass of the chemical gas of interest over time interval (i) with the stored value of the cumulative mass of the chemical gas of interest to determine the total mass of the contaminant of interest (M_{c}) (equation (9)). At 442, the method determines the percentage of the remaining life of the air filter 30 with equation (10). At 444, the method determines if the percentage of remaining life of the air filter 30 is greater than a predefined remaining filter life threshold value, such as about 15%. If the percentage of remaining life of the air filter 30 is greater than a predefined remaining filter life threshold value, the method uses this value as the percentage of life remaining for the air filter 30 based on the chemical gas of interest (FIG. 4) and ends at 446. Otherwise, at 448, the method outputs the notification data 130 to the notification system 16 that indicates that the air filter 30 needs service and the method ends at 446.

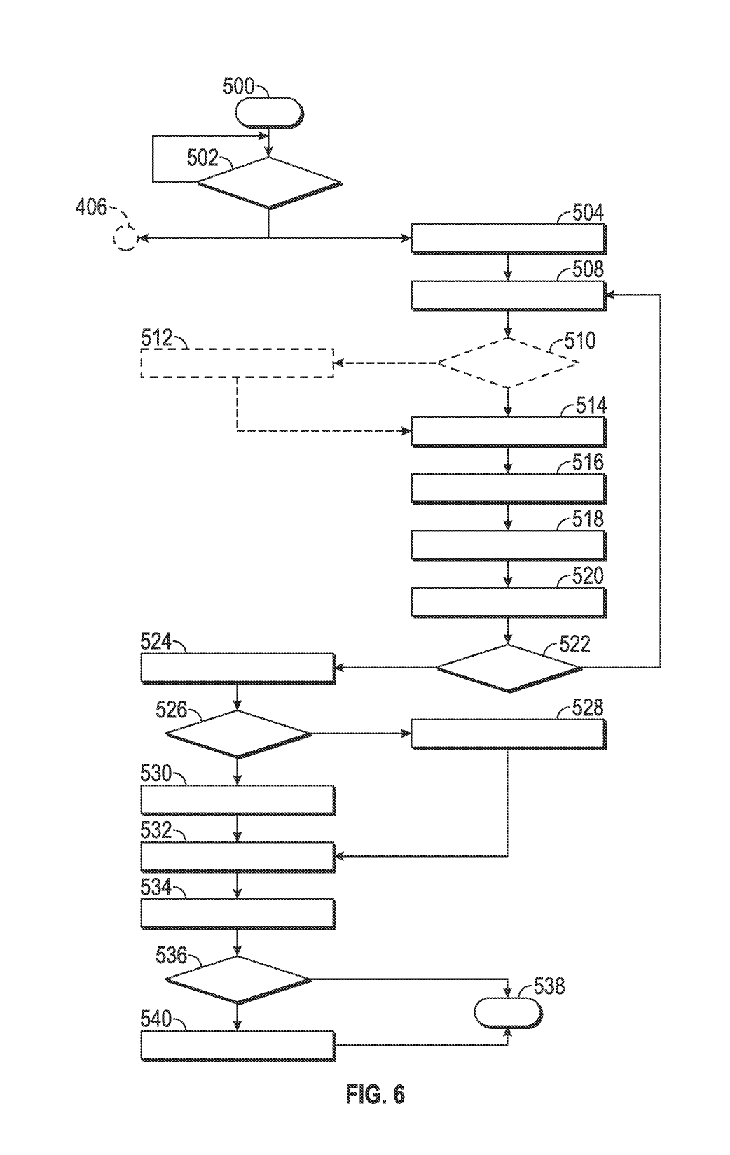

With reference to FIG. 6, in one embodiment, a method for determining a percentage of life remaining for the air filter 30 based on a chemical gas of interest is shown. The method starts at 500. At 502, the method determines if the compressor 36 is running based on the compressor data 124 (FIG. 2). If the compressor 36 is running, the method goes to 504 and, optionally, goes to 406 of FIG. 7. Otherwise, the method loops.

At 504, the method sets a timer as a start time (t₁) for the time interval (i). At 508, the method receives the first gas sensor data 118 as input. Optionally, at 510, the method determines if the chemical gas concentration for the particular gas of interest is greater than a predefined threshold value. The predefined threshold is generally the maximum allowable concentration of the contaminant gas the fuel cell stack 34 can be exposed to. Thus, the predefined threshold is defined for each contaminant gas and based on the material and configuration of the air filter 30, the fuel cell stack 34 and the compressor 36. In one example, the predefined threshold is about 10 parts per billion (ppb) to about 1000 parts per million (ppm). If the chemical gas concentration for the particular gas of interest is greater than the predefined threshold value, the method outputs the notification data 130 to the notification system 16 at 512 that indicates that the vehicle 10 is operating in high pollution.

At 514, the method receives the mass air flow sensor data 122 as input. At 516, the method reads the timer to define an end time (t₂) for the time interval (i). At 518, the method determines the averaged chemical gas concentration ( C̅_̅{̅p̅p̅b̅}̅) over the time interval (i) with equation (2). At 520, the method determines the cumulative mass of the air (mᵢ) from the mass air flow sensor data 122 over the time interval (i) with equation (3). At 522, the method determines if the difference between the end time (t₂) and the start time (t₁) is greater than a predefined threshold time value, such as about 25 milliseconds to about 10 minutes. If the difference between the end time (t₂) and the start time (t₁) is greater than the predefined threshold time value, the method goes to 524. Otherwise, the method loops to 508.

At 524, the method adds the cumulative mass of the air over the time interval (i) to a stored total mass of air to determine the total mass of air (equation (4)). It should be noted that 524 can be optional. At 526, the method determines if the correction value 111 is required. If the correction value 111 is required, the method goes to 528. At 528, the method retrieves the correction value 111 from the tables datastore 106 and determines the corrected cumulative mass (M_{C,i}) of the chemical gas of interest over the time interval (i) with equation (11). Otherwise, if the correction value 111 is not required, the method at 530 determines the cumulative mass (M_{C,i}) of the chemical gas of interest over the time interval (i) with equation (13).

At 532, the method sums the cumulative mass of the chemical gas of interest over time interval (i) with the stored value of the cumulative mass of the chemical gas of interest to determine the total mass of the contaminant of interest (M_{c}) (equation (9)). At 534, the method determines the percentage of the remaining life of the air filter 30 with equation (10). At 536, the method determines if the percentage of remaining life of the air filter 30 is greater than a predefined remaining filter life threshold value, such as about 15%. If the percentage of remaining life of the air filter 30 is greater than a predefined remaining filter life threshold value, the method uses this value as the percentage of life remaining for the air filter 30 based on the chemical gas of interest (FIG. 4) and ends at 538. Otherwise, at 540, the method outputs the notification data 130 to the notification system 16 that indicates that the air filter 30 needs service and the method ends at 538.

With reference to FIG. 7, in one embodiment, a method for determining a percentage of life remaining for the air filter 30 based on a chemical gas of interest is shown. The method starts at 600. At 602, the method determines if the compressor 36 is running based on the compressor data 124 (FIG. 2). If the compressor 36 is running, the method goes to 606. Otherwise, the method loops.

At 606, the method sets a GPS timer as a start time (t₃) for a GPS time interval. At 608, the method determines if GPS data 114 is available from the GPS system 20. If GPS data is available, the method goes to 610. Otherwise, at 612, the method retrieves the last known GPS data 114 corresponding to the last drive cycle for the vehicle 10 from the GPS system 20.

At 610, the method retrieves the air quality data 113 from the remote datastore 40 based on the position coordinates obtained from the GPS data 114. If air quality data 113 is not available from the remote datastore 40, for example due to a connection to the remote datastore 40 not being available, the method can retrieve air quality data 110 from the tables datastore 106. Optionally, at 613, the method determines if the traffic density and/or traffic speed from the GPS data 114 is greater than a predefined traffic threshold, such as average vehicle speed less than about 50% of the posted speed limit or about 20 to about 300 vehicles per minute based on the number of lanes on the road. If the traffic density and/or traffic speed is greater than the predefined traffic threshold, at 614, the method retrieves a correction value 111 from the tables datastore 106 based on the traffic density and/or traffic speed from the GPS data 114.

At 616, the method sets a timer as a start time (t₁) for a time interval (i). At 618, the method receives the mass air flow sensor data 122 as input. At 620, the method reads the timer to define an end time (t₂) for the time interval (i). At 622, the method determines the cumulative mass of the air (mᵢ) from the mass air flow sensor data 122 over the time interval (i) with equation (3). At 624, the method determines if the difference between the end time (t₂) and the start time (t₁) is greater than a predefined threshold time value, such as about 25 milliseconds to about 10 minutes. If the difference between the end time (t₂) and the start time (t₁) is greater than the predefined threshold time value, the method goes to 626. Otherwise, the method loops to 618.

At 626, the method adds the cumulative mass of the air over the time interval (i) to a stored total mass of air to determine the total mass of air (equation (4)). It should be noted that 626 can be optional. At 628, the method determines if the correction value 111, or if additional correction values 111 are required based on the GPS data 114. If the correction value 111 is required, the method goes to 630. At 630, the method retrieves the correction value 111 from the tables datastore 106 and determines the corrected cumulative mass (M_{C,i}) of the chemical gas of interest over the time interval (i) with equation (11). Otherwise, if the correction value 111 is not required, the method at 632 determines the cumulative mass (M_{C,i}) of the chemical gas of interest over the time interval (i) based on the following equation:

$${M}_{C , i} = \frac{{ρ}_{c}}{{ρ}_{air}} * \frac{{C}_{ppb}}{1 \times {10}^{9}} * {m}_{i} \qquad ( 14 )$$

Wherein M_{C,i} is the corrected cumulative mass of the chemical gas of interest over time interval (i) in kilograms (kg), ρ_{c} is the density of the contaminant gas in kilograms per meter cubed (kg/m³), ρₐᵢᵣ is the density of the air, C_{ppb} is the chemical gas concentration expressed in parts per billion (ppb) from the monitored air quality data 113; K is the correction value 111; and mᵢ is the cumulative mass of air over the time interval (i) in kilograms (kg). The density of the air and the contaminant gas are determined using equation (7) or equation (8), above.

At 634, the method sums the cumulative mass of the chemical gas of interest over time interval (i) with the stored value of the cumulative mass of the chemical gas of interest to determine the total mass of the contaminant of interest (M_{c}) (equation (9)). At 636, the method determines the percentage of the remaining life of the air filter 30 with equation (10). At 638, the method determines if the percentage of remaining life of the air filter 30 is greater than a predefined remaining filter life threshold value, such as about 15%. If the percentage of remaining life of the air filter 30 is less than a predefined remaining filter life threshold value, the method outputs the notification data 130 to the notification system 16 that indicates that the air filter 30 needs service at 640 and the method ends at 642.

Otherwise, the method uses the percentage of remaining life of the air filter value as the percentage of life remaining for the air filter 30 based on the chemical gas of interest (FIG. 4) and goes to 644. At 644, the method reads the GPS timer to define an end time (t₄) for the GPS time interval. At 646, the method determines if the difference between the end time (t₄) and the start time (t₃) for the GPS time interval is greater than a predefined threshold GPS time value, such as about one hour to about four hours. If the difference between the end time (t₄) and the start time (t₃) is greater than the predefined threshold GPS time value, the method ends at 648. Otherwise, the method loops to 618.

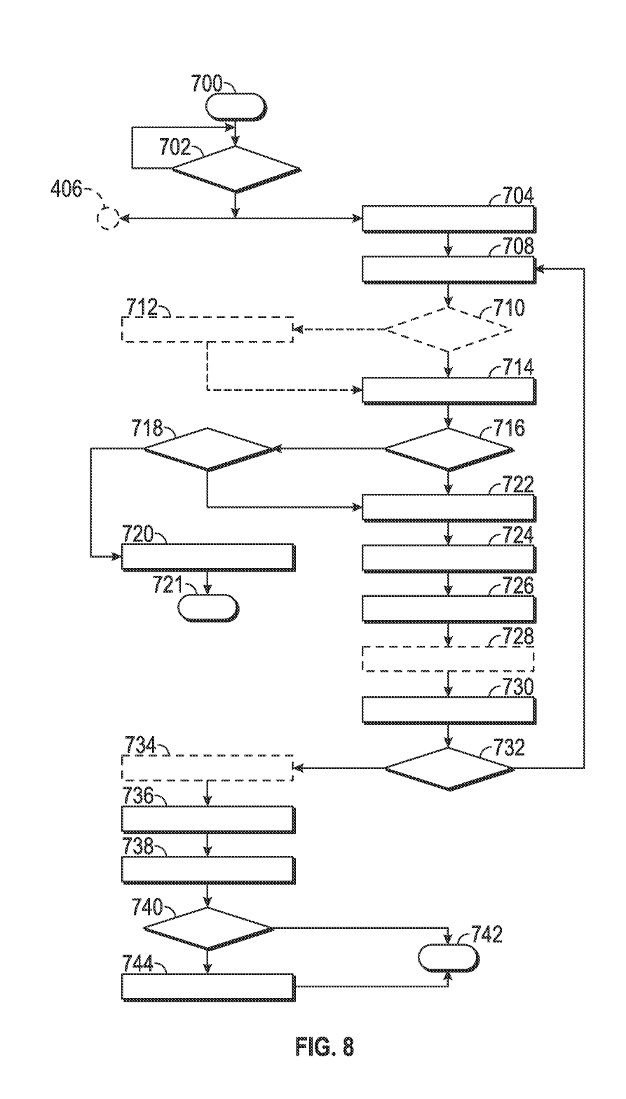

With reference to FIG. 8, in one embodiment, a method for determining a percentage of life remaining for the air filter 30 based on a chemical gas of interest is shown. It should be noted that the method of FIG. 8 is similar to the method of FIG. 5, however, in this embodiment, the method determines the corrected cumulative mass (M_{C,i}) of the chemical gas of interest prior to determining if the difference between the end time (t₂) and the start time (t₁) is greater than a predefined threshold time value. Thus, the methods illustrated herein are merely exemplary, and further, the methods of FIG. 6 and FIG. 7 can also be modified similar to the method of FIG. 8, in which the method determines the corrected cumulative mass (M_{C,i}) of the chemical gas of interest prior to determining if the difference between the end time (t₂) and the start time (t₁) is greater than a predefined threshold time value.

With continued reference to FIG. 8, the method starts at 700. At 702, the method determines if the compressor 36 is running based on the compressor data 124 (FIG. 2). If the compressor 36 is running, the method goes to 704 and, optionally, goes to 406 of FIG. 7. Otherwise, the method loops. It should be noted that the use of the compressor data 124 is merely exemplary, and the method can run based on other events, such as an ignition on event.

At 704, the method sets a timer as a start time (t₁) for the time interval (i). At 708, the method receives the first gas sensor data 118 and the second gas sensor data 120 as input. Optionally, at 710, the method determines if the chemical gas concentration for the particular gas of interest is greater than a predefined threshold value (pollution data 125). The predefined threshold is generally the maximum allowable concentration of the contaminant gas the fuel cell stack 34 can be exposed to. Thus, the predefined threshold is defined for each contaminant gas and based on the material and configuration of the air filter 30. In one example, the predefined threshold is about 10 parts per billion (ppb) to about 1000 parts per million (ppm). If the chemical gas concentration for the particular gas of interest is greater than the predefined threshold value, the method outputs the notification data 130 to the notification system 16 at 712 that indicates that the vehicle 10 is operating in high pollution.

Otherwise, at 714, the method determines the instantaneous efficiency (E_{inst.}) or efficiency data 127 for the air filter 30 for the chemical gas of interest based on the first gas sensor data 118 and the second gas sensor data 120 with equation (1). At 716, the method determines if the instantaneous efficiency of the air filter 30 is greater than a predefined value, for example, about 50% to about 100%. If the instantaneous efficiency of the air filter 30 is not greater than the predefined value, the method determines if the air filter 30 passes a diagnostic test for the air filter 30 at 718. If the air filter 30 passes the diagnostic test, then the method goes to 722. Otherwise, if the air filter 30 does not pass the diagnostic test, the method outputs the notification data 130 to the notification system 16 that indicates that the air filter 30 needs service at 720. The method ends at 721.

In one example, the diagnostic test comprises determining a ratio between a number of instantaneous efficiency (E_{inst.}) values that are below the predefined value and the total number of instantaneous efficiency (E_{inst.}) values. If the ratio is greater than 0.5, the method goes to 720. If the ratio is less than 0.5, the method goes to 722.

If, at 716, the instantaneous efficiency of the air filter 30 is greater than the predefined value, at 722, the method receives the mass air flow sensor data 122 as input. At 724, the method reads the timer to define an end time (t₂) for the time interval (i). At 726, the method determines the cumulative mass of the air (mᵢ) from the mass air flow sensor data 122 over the time interval (i) with equation (3). At 728, optionally, the method determines the averaged chemical gas concentration ( C̅_̅{̅p̅p̅b̅}̅) over the time interval (i) with equation (2). It should be noted that the method need not determine the averaged chemical gas concentration ( C̅_̅{̅p̅p̅b̅}̅), but can determine a single chemical gas concentration.

At 730, the method determines the correction factor α based on equation (5) and determines the corrected cumulative mass (M_{C,i}) of the chemical gas of interest over the time interval (i) with equation (6). If the correction factor α is not required, the method determines the correction factor α is equal to one. At 732, the method determines if the difference between the end time (t₂) and the start time (t₁) is greater than a predefined threshold time value, such as about 25 milliseconds to about 10 minutes. If the difference between the end time (t₂) and the start time (t₁) is greater than the predefined threshold time value, the method goes to 734. Otherwise, the method loops to 708.

At 734, optionally, the method adds the cumulative mass of the air over the time interval (i) to a stored total mass of air to determine the total mass of air (equation (4)). At 736, the method sums the cumulative mass of the chemical gas of interest over time interval (i) with the stored value of the cumulative mass of the chemical gas of interest to determine the total mass of the contaminant of interest (M_{c}) (equation (9)). At 738, the method determines the percentage of the remaining life of the air filter 30 with equation (10). At 740, the method determines if the percentage of remaining life of the air filter 30 is greater than a predefined remaining filter life threshold value, such as about 15%. If the percentage of remaining life of the air filter 30 is greater than a predefined remaining filter life threshold value, the method uses this value as the percentage of life remaining for the air filter 30 based on the chemical gas of interest (FIG. 4) and ends at 742. Otherwise, at 744, the method outputs the notification data 130 to the notification system 16 that indicates that the air filter 30 needs service and the method ends at 742.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method of monitoring an air filter, comprising:
receiving data indicating a concentration of a contaminant gas;
receiving data indicating a mass flow rate through the air filter;
determining, with a processor, a total mass of the contaminant gas based on the concentration of the contaminant gas and the mass flow rate;
calculating, with the processor, a remaining life of the air filter based on the total mass of the contaminant gas and a capacity of the air filter for the contaminant gas; and
outputting notification data to a notification system based on the calculated remaining life of the air filter.

2. The method of claim 1, wherein receiving data indicating the concentration of the contaminant gas further comprises:
receiving air quality data from a remote database based on a geographic location of a vehicle, the air quality data including the concentration of the contaminant gas.

3. The method of claim 1, wherein receiving data indicating the concentration of the contaminant gas further comprises:
receiving sensor data from a first sensor upstream from the air filter; and
receiving sensor data from a second sensor downstream from the air filter.

4. The method of claim 4, further comprising:
determining an instantaneous efficiency of the air filter based on the sensor data from the first sensor and the sensor data from the second sensor; and
outputting the notification data to the notification system based on the instantaneous efficiency.

5. The method of claim 4, further comprising:
determining a correction factor for a filtration efficiency of the air filter based on the sensor data from the first sensor and the sensor data from the second sensor; and
calculating, with the processor, the remaining life of the air filter based on the total mass of the contaminant gas, the capacity of the air filter for the contaminant gas and the correction factor.

6. The method of claim 1, wherein determining the total mass of the contaminant gas further comprises:
determining, with the processor, a cumulative mass of the contaminant gas over a time interval based on a concentration of the contaminant gas during the time interval and a mass flow rate during the time interval; and
summing the cumulative mass of the contaminant gas over a plurality of time intervals to determine the total mass of the contaminant gas.

7. The method of claim 6, wherein receiving data indicating the mass flow rate through the air filter further comprises:
receiving the mass flow rate of air, a temperature of the air and a relative humidity of the air from a mass flow sensor downstream from the air filter.

8. The method of claim 7, further comprising:
retrieving a correction value for the cumulative mass of the contaminant gas over the time interval from a datastore based on at least one of the mass flow rate of the air, the temperature of the air and the relative humidity of the air; and
determining, with the processor, a corrected cumulative mass of the contaminant gas over the time interval based on the correction value.

9. The method of claim 1, further comprising:
receiving data indicating a concentration of a second contaminant gas;
determining, with the processor, a total mass of the second contaminant gas based on the concentration of the second contaminant gas and the mass flow rate;
calculating, with the processor, a remaining life of the air filter based on the total mass of the second contaminant gas and a capacity of the air filter for the second contaminant; and
outputting the notification data to the notification system based on the calculated remaining life of the air filter for the contaminant gas and the calculated remaining life of the air filter for the second contaminant gas.

10. A vehicle, comprising:
an air filter;
at least one sensor that measures a concentration of a gas;
a mass flow sensor disposed downstream of the air filter that measures a mass flow rate through the air filter;
a notification system; and
a module that determines a remaining life of the air filter based on the concentration of the gas, the mass flow rate and a capacity of the air filter for the gas, and outputs notification data to the notification system based on the remaining life of the air filter.

11. The vehicle of claim 10, wherein the at least one sensor is arranged upstream from the air filter.

12. The vehicle of claim 10, wherein the at least one sensor comprises a first sensor arranged upstream from the air filter that measures a first concentration of the gas and a second sensor arranged downstream from the air filter that measures a second concentration of the gas.

13. The vehicle of claim 10, further comprising:
a source of global position system data that indicates a geographic location of the vehicle and the module queries a remote datastore to obtain a concentration of the gas based on the geographic location of the vehicle.

14. The vehicle of claim 10, further comprising:
a fuel cell stack, and the air filter is in communication with the fuel cell stack to supply filtered gas to the fuel cell stack.

15. The vehicle of claim 12, wherein the module calculates an efficiency of the air filter based on the first concentration of the gas and the second concentration of the gas, and outputs notification data to the notification system based on the calculated efficiency.

16. A method of monitoring an air filter of a vehicle, comprising:
receiving data indicating a first concentration of a contaminant gas from a first sensor arranged upstream from the air filter;
receiving data indicating a mass flow rate through the air filter;
determining, with a processor, a total mass of the contaminant gas based on the first concentration of the contaminant gas and the mass flow rate; and
calculating, with the processor, a remaining life of the air filter based on the total mass of the contaminant gas and a capacity of the air filter for the contaminant gas.

17. The method of claim 16, further comprising:
receiving data indicating a second concentration of the contaminant gas from a second sensor downstream from the air filter;
determining an instantaneous efficiency of the air filter based on the data from the first sensor and the data from the second sensor; and
outputting notification data to a notification system of the vehicle based on the instantaneous efficiency.

18. The method of claim 17, further comprising:
determining a correction factor for a filtration efficiency of the air filter based on the data from the first sensor and the data from the second sensor; and
calculating, with the processor, the remaining life of the air filter based on the total mass of the contaminant gas, the capacity of the air filter for the contaminant gas and the correction factor.

19. The method of claim 17, further comprising:
determining, with the processor, if the second concentration of the contaminant gas is greater than a predefined threshold for the contaminant gas; and
outputting notification data to a notification system of the vehicle based on the determination.

20. The method of claim 16, wherein determining the total mass of the contaminant gas further comprises:
determining, with the processor, a cumulative mass of the contaminant gas over a time interval based on the first concentration of the contaminant gas during the time interval and a mass flow rate during the time interval; and
summing the cumulative mass of the contaminant gas over a plurality of time intervals to determine the total mass of the contaminant gas.
